(19) United States
(12) Patent Application Publication
(10) Pub. No.: US 2012/0135703 A1
(43) Pub. Date: May 31, 2012

(54) Mycchild modified cellphone locating devices

(75) Inventor: Jesse Bryan Hartt, Auburn, CA (US)

(73) Assignee: Jesse Bryan Hartt, Auburn, CA (US)

(21) Appl. No.: 13/200,167

(22) Filed: Sep. 19, 2011

Related U.S. Application Data
(60) Provisional application No. 61/403,782, filed on Sep. 20, 2010.

(51) Int. Cl. H04W 4/22; B23P 17/04

(52) U.S. Cl. 455/404.2; 29/401.1

(57) ABSTRACT

The present invention is a new process (method) of making, manufacturing, operating, locating, and providing service for a Child Emergency Locating Device (CELD). The invention uses the resources of technology the cell phone industry uses to operate and locate cell phones. This technology is used to provide the operational and locating capabilities in the invention. It's used in a new method that is different from cell phones. The invention is made small and is used in a strategically concealed and silent manner so when in use, no one knows the child is using the device. The purpose of the invention is to provide mankind the best means of locating lost/abducted children quickly and inexpensively. Since the cell phone industry has such vast resources to locate their phones, they can make the CELDs inexpensively. The savings means parents can afford to protect their children should they become lost or abducted.

### CROSS-REFERENCE TO RELATED APPLICATIONS

This non-provisional utility patent application claims the benefit of provisional patent application No. 61/403,782 and filing date Sep. 20, 2010. The application is a complete version of the provisional application.

### STATEMENT REGARDING FEDERALLY SPONSORED RESEARCH OR DEVELOPMENT

Not Applicable

### FIELD OF THE INVENTION

The present invention relates to locating devices and cell phone devices. Specifically, it is a way to make a Child Emergency Locating Device (CELD) that is small, silent and easy to conceal on the clothing of a child/wearer. This device is not a cell phone, but it uses the operating and locating means which enable cell phones to be found on cell phone service. The device is used to find lost or abducted children.

### BACKGROUND OF THE INVENTION

When I started on the present invention, I did not know that there were child locating devices on the market. After some research, I found that there were several. However, the devices as well as the service were expensive and complicated to purchase. Moreover, the companies were ones that neither I nor my acquaintances had heard of, which indicated that their marketing was not effective. For the above reasons, I concluded that these companies were not meeting their goal to help lost or abducted children, which is a tragedy.

There is a serious need for a solution to this problem. In the US, the increase in missing children since 1982 is 468%, so it's no surprise that the FBI receives over 2,000 missing child reports every day. Another child goes missing every 40 seconds, 24 hours a day, 365 days a year. The US Department of Justice and the World Almanac place the chances of any child being abducted at 1 in 42. However, about half of all children abducted are between 4 and 11 years old.

The cell phone industry is already involved in providing services to locate family members through their phones, In fact, in 2005, the FCC ruled that all cell phones transmit their phone numbers and location when dialing 911, which is why cell phone manufacturers have built GPS into phones. Unfortunately, if a family member were to be abducted, the first thing an abductor would take would be their cell phone. As previously mentioned, 50% of children abducted are between 4-11 years old and most in this age bracket don't carry cell phones; there are 25 million children in this age range in the US and ten times this amount worldwide, and there remains no way to protect them in an abduction situation.

An effective solution to the child abduction crisis is the present invention, which is a process (method) of making a CELD from cell phone parts, as well as using cell phone operating and locating technology and cell phone service. The demonstration phone mentioned in the step-by-step instructions in the Detailed Description of the Drawings below, and which I used for this invention is the Motorola V3m. Let it be clear that this phone was used for demonstration purposes only in the making of the demonstration CELD described below, and the present invention is in no way connected with Motorola, nor does the present invention require Motorola parts or a certain type or make of any brand of cell phone to be effective. Indeed, with the cell phone industry advancing at such an incredible pace, today's top selling cell phones will be outdated or obsolete tomorrow. The present invention utilizes these cell phones, recycling them to produce an effective and affordable child emergency location device.

Although there are other inventions for child emergency locating devices, the present invention is distinctly unique. During the patentability search for this invention, the following patent documents for child emergency location devices were discovered. U.S. Pat. Nos. 5,365,570; 7,308,246; 6,785,387; 7,251,471; Des. 491,157; 6,243,039; 6,636,732; 5,515,419; 7,251,458; 5,021,794. However, unlike the present invention, a) not one of these follows the present invention process (method) set forth in this application, and b) none operate on existing cell phone service.

Reference information and statistics used in this application came from the following documents:
“AT&T Family Map” at familymap.wireless.att.com
“Child Abduction Statistics” by kidsafe.com
“How Cellphones Work” by howstuffworks.com
“How Location Tracking, Smartphones, GPS Phones and GPS Receivers Work” by howstuffworks.com
“The Ultimate GPS Child Tracking Buyers Guide” by GPSmagazine.com
“US Census on Children in the USA” at usgov.com/census

### BRIEF SUMMARY OF THE INVENTION

The purpose of making the present invention is to provide mankind with a viable means of finding lost or abducted children in a quick and inexpensive manner so that all parents and guardians can afford to protect their children.

The present invention is the process of creating a locating device that is made from cell phone parts and technology and operates on cell phone service. Unlike a cell phone, which is always visible during use and produces sound, the present invention is small and easily concealed in the child/wearer's clothing in order to hide the fact that children/wearers have the device on them. Furthermore, the device emits no sounds so as to not give away its concealment on the child/wearer in an abduction situation.

In one embodiment, the present invention is a new process to make locating devices by recycling cell phones that are outdated, obsolete or deemed unmarketable by the cell phone industry. The parts and components are used to build the CELDs. This would result in fewer phones in landfills and offer a “green” solution to dealing with much of society's cell phone waste.

In another embodiment, the CELD components can be manufactured rather than gathered from recycled cell phones while still using the present invention's new process (method) to manufacture said locating devices.

Another embodiment describes the process of how a cell phone operates and is located through cell phone service, which is a new process (method) of locating lost/abducted children with the child emergency locating device such as those described in the previous embodiments (in 0011 and 0012).

### BRIEF DESCRIPTION OF THE DRAWINGS

FIGS. 1, 1a, 1b, 1c, and 1d illustrate the several views of the present invention's case.

FIG. 2 illustrates a Motorola V3m cell phone that was used for the demonstration purposes only and Motorola is in no way connected to the present invention.

FIG. 3 illustrates the top flip cover of the cell phone.

FIG. 4 illustrates the electronic screen panel of the top flip of the cell phone.

FIG. 5 illustrates the battery compartment of the cell phone.

FIG. 6 illustrates the printed circuit board, or mainboard with the connecting ports.

FIG. 7 through 7e illustrate the keypad/battery frame in different stages of modification.

FIG. 8 illustrates the ground for the mainboard.

FIG. 9 illustrates the keypad/circuit.

FIG. 10 illustrates the Gatwick Hinge flex connector that connected the top flip electronic screen panel to the mainboard.

FIG. 11 illustrates the Gatwick hinge flex connector needed for the present invention.

FIG. 12 illustrates the battery used.

FIG. 13 illustrates the keypad activation buttons that get removed from the keypad/circuit in the present invention.

FIG. 14 illustrates the battery/mainboard adapter for the present invention.

FIG. 15 illustrates the components of the locating device in the order they will be configured in.

### DETAILED DESCRIPTION OF THE INVENTION

The present invention is detailed in one or more of the embodiments in the following description with reference to the figures, in which like numerals represent the same or similar elements. While the invention is described in terms of the best mode for achieving the invention objectives, it will be appreciated by those skilled in the art that it is intended to cover alternatives, modifications and equivalents as may be included within the spirit and scope of the invention as defined by the appended claims and their equivalents as supported by the following disclosure and drawings.

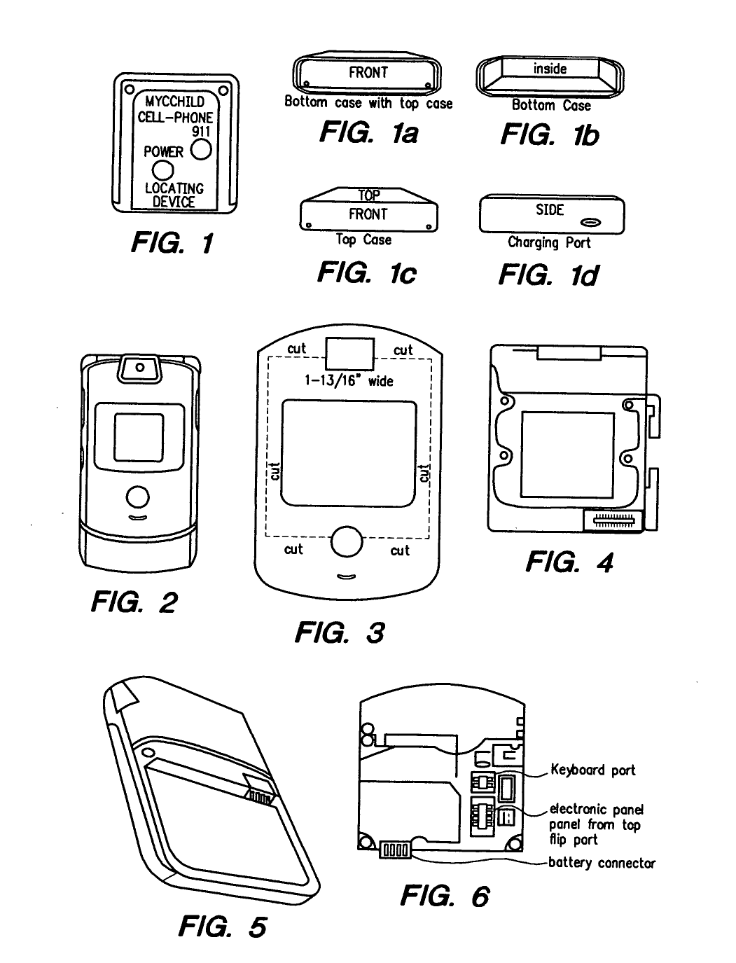

FIG. 1 is the top view of the present invention and is intended to be the front page of the patent application publication and patent as the illustration of the invention.

FIG. 2 is a Motorola V3m Cell phone that was used for demonstration purposes only. The present invention is not connected to and is in no way implied that it has any ties to Motorola. With the variety of cell phones on the market, the modifications will vary, but will stay within the spirit and scope of the present invention.

In the demonstration cell phone used, all of the electronic components of the cell phone were used except the camera, the speakers, and microphone, which don't not change the circuitry. With no modifications to the circuitry, the costs are kept to a minimum.

Step 1: Before the cell phone is taken apart, with the battery in and charged, turn the phone on and make sure the locating capabilities are also on. When on, there will be a locator icon that appears on the top of the screen.

Step 2: Remove the speakers and microphone. However, they could be left in if the master volume can be turned off or permanently disengaged. This step is vital because it is imperative that the device make no sound so as to not give away its concealment in an abduction or emergency situation.

Step 3: Set the number 2 button on the speed dial to 911. With the one touch option, the child/wearer will be able to press and hold the button for one second and not have to press the send button. This button is used in an emergency situation but only if the wearer can activate it without giving away the concealment of the device.

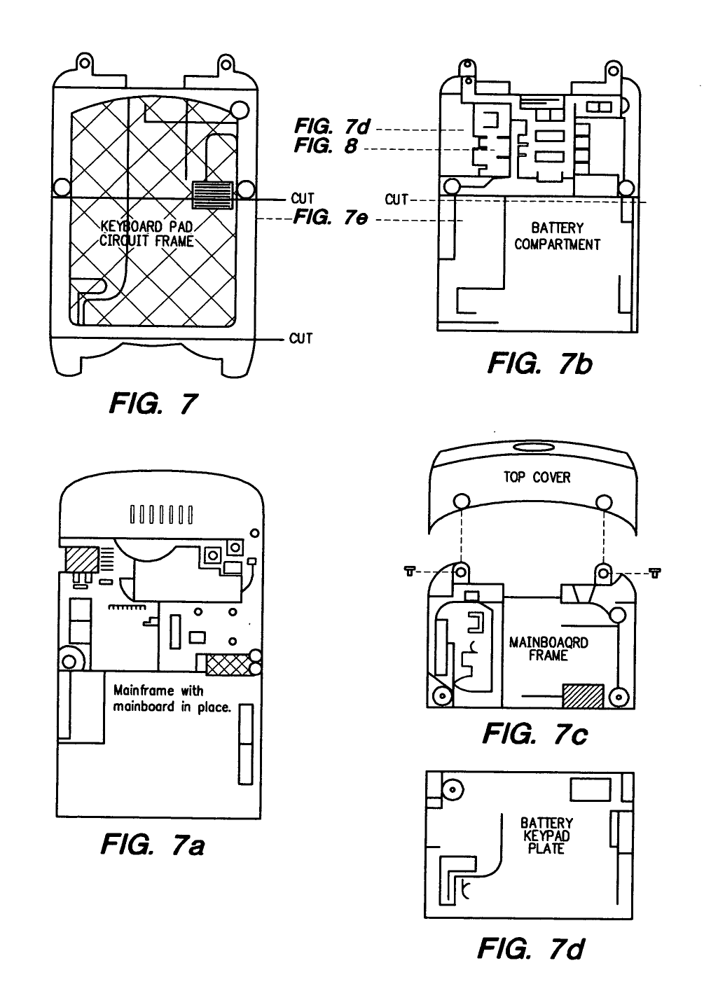

Step 4: Remove the cover that is shown in FIG. 3 to gain access to the electronic screen panel FIG. 4. Do not discard the cover in FIG. 3 as it will be used as a ground plate later in the application. As an alternative, a thin metal ground plate could be manufactured for this purpose as well as for FIGS. 7d and 7e.

Step 5: Turn the cell phone over, back side up, and remove and discard the battery cover in FIG. 12. Keep the battery. Remove the two screws from the battery compartment in FIG. 5.

Step 6: Turn the cell phone back over, top side up, and remove the keypad function cover and peel back the glued in the keypad/circuit in FIG. 9 removing it from the keyboard circuit frame, FIG. 7 (so that the frame in FIG. 7 can be cut later) but leaving it connected to the mainboard port, FIG. 6.

Step 7: Disconnect the Gatwick Hinge flex connector FIG. 10 from the electronic screen panel FIG. 4 and remove screen panel FIG. 4. Save the connector in FIG. 10 so you can use the part number on the connector FIG. 10 and contact a Gatwick representative to make the new connector FIG. 11 to fit the application, in Step 10 in (0042).

Step 8: Cut the keypad frame FIG. 7 on the cut lines shown in the illustration. Remove the flip and hinge and discard. The unit will look like FIG. 7b from the bottom.

Step 9: Turn the unit back over and remove the top cover FIG. 7c, which will still be connected to FIG. 7d by two screws. Remove the screws and cut FIG. 7 on the cut lines in the illustration so it looks like FIG. 7d and FIG. 7e for the purpose of making the mainboard frame, FIG. 7d and the battery keypad plate, FIG. 7e.

Step 10: Access and remove the Gatwick Hinge flex connector in FIG. 10 and the keypad/circuit connector FIG. 9 from the mainboard ports FIG. 6. Then, put the Gatwick Hinge flex connector FIG. 11 into the mainboard port FIG. 6 and the flexible keypad/circuit FIG. 9.

Step 11: To modify the keypad/circuit, peel open the protective cover and remove all the keypad activation buttons FIG. 13 except the power button, which has a red circle on the white protective cover, and the number 2 button, which is used for the one touch speed dial function. The reason the keypad activation buttons FIG. 13 are removed is so they don't accidentally get pushed and cause a function which might interfere with the necessary functions. As an alternative, FIG. 9, a flexible keypad/circuit, could be manufactured so the connector is in the center of the side and since only two functions are used for the present invention—on/off and Emergency 911 on the number 2 on speed dial—the keypad/circuit can be made much smaller for the present invention.

Step 12: Next, seal the protective cover back in place and reconnect to the mainboard port FIG. 6.

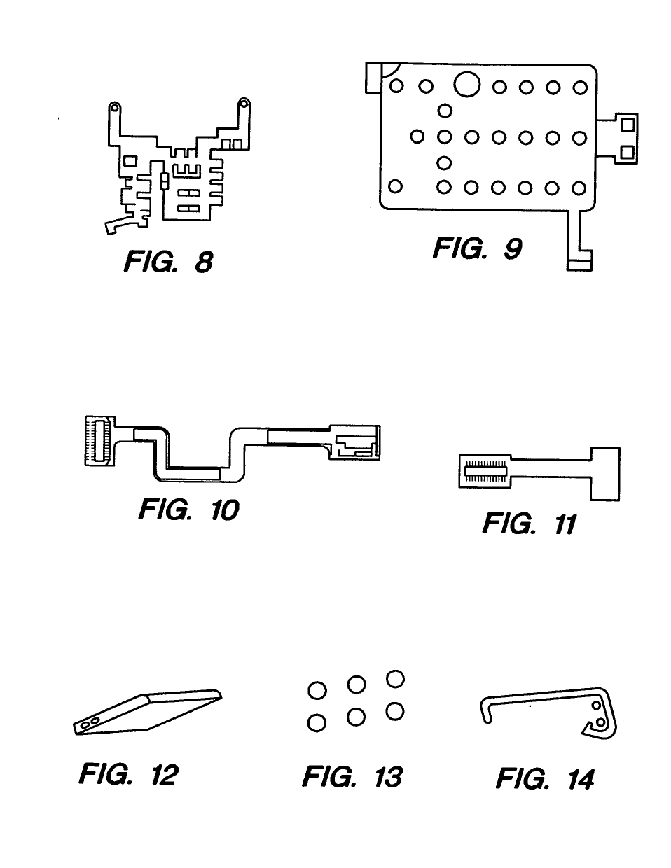

Step 13: Make a small cut in the plastic above the battery connector on the bottom of the mainboard as shown in FIG. 5. and reassemble in the reverse order, making sure not to forget the ground for the mainboard FIG. 8 and the ground straps depicted in FIG. 15.

Step 14: Put foam with adhesive spacers as depicted in FIG. 15 on all four corners of the new bottom case FIG. 1 c, which has a clear window on the bottom so as to be able to see the charge function indicator and light to know if the device is on or off on the screen panel FIG. 4.

Step 15: Place the screen panel, FIG. 4, inside the bottom case FIG. 1c big screen down and set the mainboard FIG. 6 in front, upside down. Hook Gatwick Hinge flex connector FIG. 11 to the screen panel port in FIG. 4.

Step 16: Cut the top flip cover, FIG. 3, on the cut lines shown in the illustration and glue it in place on the screen panel FIG. 4 in its original position. Now adhere the foam with adhesive spacers on the four corners of the cover FIG. 3 and flip the mainboard FIG. 6 on top of the cover FIG. 3.

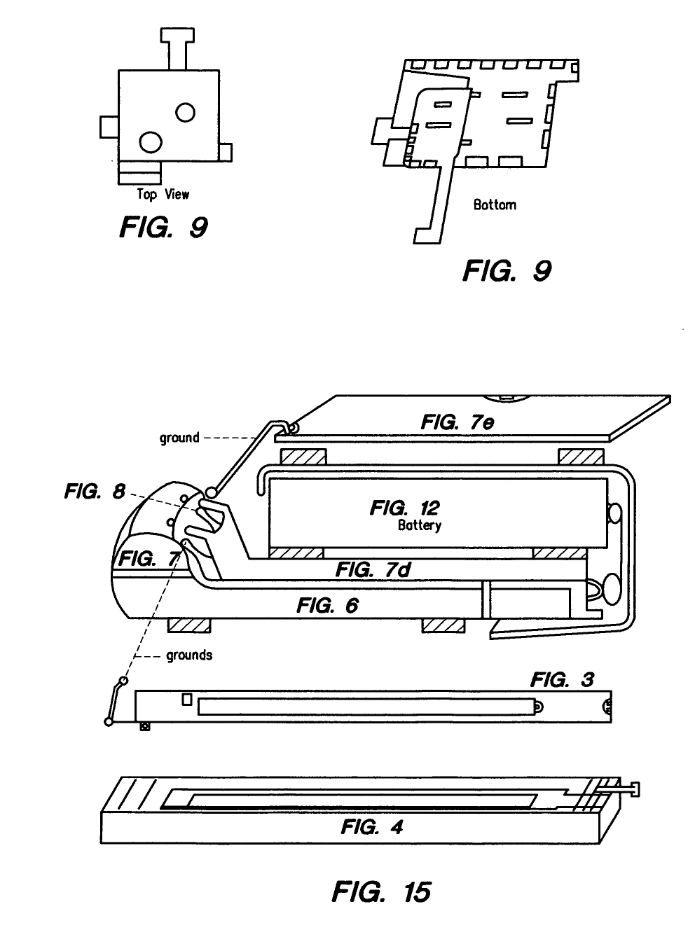

Step 17: FIG. 14 is a battery/mainboard adapter that is a plastic connector. Snap it on over the back edge of the battery FIG. 12 and the battery connector depicted in FIG. 6. The adapter has two copper strips molded in the plastic and rolled on each end to make the connection with battery FIG. 12 and the mainboard FIG. 6. The length of the adapter FIG. 14 is ⅛″ longer than the width of the battery FIG. 12 and the copper strips are 3/16″ so when snapped in place, the strips with the rolled ends apply a constant pressure to make a solid connection. On the back of the adapter, there is a rubber pad glued on so that when the top cover FIG. 1b makes contact with the adapter, the connector cannot come loose, which adds a safety feature.

Step 18: Put the battery FIG. 12 on the battery/keypad frame FIG. 7d, and make sure the contact points are aligned. Then, put the adapter FIG. 14 on as described in Step 17. Adhere four spacers with foam adhesive on the corners of the battery FIG. 12 and put the battery/keypad plate FIG. 7e on top with the battery side down. Glue the keypad/circuit FIG. 9 to the top of the battery/keypad plate FIG. 7e as depicted in FIG. 15. Be sure to fold as depicted in FIG. 15 OR as the alternate method explained in Step 11.

Step 19: Now put the top case FIG. 1b onto the bottom case FIG. 1c, which will now look like FIGS. 1 and 1a and put the screws in the corners. The top case FIG. 1 has two holes, ⅜″ over the Power and the Emergency 911 buttons, which are inset. The holes for the buttons have a rubber film glued on to seal them. The charging port is on the side of the bottom case FIG. 1d.

This should complete the steps necessary for making the CELD following the process (method) of the present invention. This process began with a cell phone and has resulted in a CELD made from cell phone components.

The present invention, can be made of cell phone components or equivalent. Or it can be manufactured using the necessary components and technology and by making a small case to house said components. By doing so it stays within the spirit and scope of the present invention. The components are a small printed circuit board that contains analog to digital and digital to analog conversion chips or their equivalent, a digital signal processor for the transmission mode technology for the service provider, the microprocessor, and the ROM or flash memory or an equivalent. The microprocessor handles the functions for the keypad and display along with the command and control signals with the base station. The ROM and flash memory chips store the operating system features. A radio frequency and power section handles the power management and charging and the radio frequency amplifiers for the antenna to get a signal, along with these subcomponents or their equivalents. The cell phone codes (ESN), (MIN), and (SID), are all used and on some units a SIM card is used or an equivalent. There is also a backup battery for the internal clock. As well there are subcomponents capable of receiving GPS signals in order to calculate the coordinate address and/or transmit the address to a receiving device. A GPS antenna and a lithium-ion battery or an equivalent will be used as will such mechanisms as an LED or similar type of light indicator to indicate that the device is on and functioning properly if the screen panel is not used.

The following embodiment is a detailed description of the process (method) of the present invention and how the present invention uses cell phone provider service and locating technology. In order to understand how the present invention works, and the detailed description of the process, one needs to understand the working means of cell phones and cell phone service. This is because cell phone service is used in the present invention, but for a different purpose. For this reason, the operating and locating means and technology will be thoroughly explained in a detailed description below.

Transmission mode technology is the way a cell phone service provider sends the signal so more cell phones can operate in a cell. TDMA stands for Time Division Multiple Access. Time is the access method. Division means splitting the call according to the access method. Multiple Access means more than one user can utilize each cell. TDMA assigns each call a certain portion of time on a designated frequency.

The cell phone codes are the identification numbers each cell phone has. The Electronic Serial Number (ESN) is the Federal identification. The Mobile Identification Number (MIN) is the 10 digit number of the cell phone used to identify and locate the cell phone. In tandem with the MIN, The System ID Code (SID) is the number that identifies the service provider. It is also used in the identification and locating of the cell phone.

Each cell phone service provider has a Mobile Telephone Switching Office (MTSO), which handles all the calls through an incredible computer system that connects calls and keeps track of phones' locations in a database. Therefore, the MTSO knows the cell your phone is in when you get a call.

When a call is made, the phone sends the MIN along with the SID on the service provider's radio frequency bands using the service provider's transmission mode technology. The MIN and SID are sent to the MTSO of the service provider along with a registration request to locate the phone in the MTSO's database. Therefore, the MTSO knows which cell the phone is in to contact. The MTSO picks a frequency pair in the service provider's designated frequencies that the phone will use in that cell to take the call. The MTSO communicates with the phone over the control channel which tells it which frequencies to use and once the phone and the tower switch on those frequencies, the call is connected.

The Global Positioning System (GPS) is a system of 27 earth-orbiting satellites in which 24 are in operation at all times. The satellites circle the globe 2 times a day. The GPS receiver's job is to locate 4 or more of these satellites and figure out the distance to each and deduce their location. This operation is called trilateration. To make this calculation, the GPS receivers need to know the location of at least 3 satellites and the distance between the receiver and each of the satellites. The GPS receiver figures this out by analyzing high frequency-low power radio signals from the GPS satellite. The satellite and receiver both send a pseudo-random code (PRC). When the PRC reaches the receiver, the transmission pattern will lag behind the receiver's pattern. The length of the delay is equal to the signal's travel time. The receiver multiplies this time by the speed of light to determine how far the signal traveled. The receiver and the satellite both use clocks that can be synchronized down to the nanosecond. The GPS receiver stores and almanac that tells it where every satellite should be at any given time. The most essential function of the GPS receiver is to pick up the transmissions of at least 4 satellites and combine the information in those transmissions with the information in the almanac to figure the receivers position on earth.

In 2005, the Federal Communications Commission (FCC) required all cell phone manufacturers and service providers to have Phase II of the Emergency 911 (E911) system be in place. Phase II requires carriers to place GPS receivers in cell phones in order to deliver specific longitude and latitude information

Because of this requirement, when a phone calls E911, the call is automatically forwarded to a Public Safety Answering Point (PSAP), which is an E911 call center. When answered, the Emergency 911 operator is provided with Automatic Location Information (ALI) pinpointing the exact location of the call.

In the present invention, this is used if the CELD Emergency 911 button is activated by the child/wearer. Or if the parent/concerned party knows the child/wearer is missing or abducted, and gives the E911 operator the contact number of the CELD and information that child/wearer is wearing the CELD.

When E911 calls the CELD's contact number, the Phase II system is used in reverse, so when contact is made to the GELD by E911, the operator knows the location of the child/wearer immediately and it is shown by the E911 operator's computer, which is linked to the ALI database, which stores address data and other information.

Another way to track a cell phone is to download the software for GPS tracking into the cell phone from sites such as Mologogo.com. This will enable parents/concerned parties to access the site which can be an APP on a smartphone to check the location of the cell phone, or in the present invention, the CELD.

In the present invention, this technology is used in the CELD to have several ways of checking on the child/wearer, which could save the child/wearer in an emergency/abduction situation. First, the parent can check to see where the child/wearer is, and if he/she is not in an appropriate location can go to the exact location the child/wearer is and determine if an abduction/loss has occurred and decide what to do about it.

Second, the parent/concerned party can contact E911 if the child/wearer appears to have been abducted/lost and law enforcement can be dispatched for a rescue with accurate information about the child/wearer's location.

Although the primary use of the present invention's CELD device is to locate lost or abducted children, it has other uses as well. The device could be placed on wearers other than children whose whereabouts need to be monitored. It could also be placed on pets. Or it could be placed on or inside valuable objects or possessions that are considered likely to be stolen in order to recover them from theft.

While one or more embodiment of the present invention has been illustrated in detail, the skilled artisan will appreciate that modifications and adaptations to those embodiments may be made without departing from the scope and spirit of the present invention as set forth in the following claims.

1. The present invention is a new process (method) of making and manufacturing Child Emergency Locating Devices (CELDs).
By modifying a cell phone to be a CELD that is as small as possible and using the necessary components so as to be able to operate and be located through cell phone service.
By manufacturing a CELD using this patent application as a guide
By configuring the components in such a way as to make the device as small as possible
By modifying or manufacturing the keyboard to have only 2 functions: on, off, and Emergency 911 and to be as small as possible
By modifying or manufacturing the mainframe with is also the ground for the invention and to be as small as possible.
By using a small screen panel or LED lights for indicators on power supply and on/off function if screen panel is not used.
By modifying or manufacturing the invention so as to emit no sound.
By manufacturing a case to house the components and make it as small as possible.

2. The present invention creates a new process (method) of use for cell phones and cell phone service.
A new method of locating lost or abducted children by using the cell phone operating and locating technology and cell phone service. Unlike cell phones, which are used in a visible manner, the present invention is concealed, and no sound is emitted.
By making a CELD from cell phones or their components, which is used in a concealed manner so no one knows the wearers have the device on them.
By making the invention silent, so as not to give away its concealment on the child or wearer.
By making the invention as small as possible so as to be able to strategically conceal the invention so that in an abduction situation, the abductor, would not know or could not easily find said invention.
By using the operating and locating means and technology to create a CELD that operates on cell phone service.
By using cell phone service in a new way, to find lost or abducted children.
By using cell phone service to quickly locate lost or abducted children by using the technology that the FCC has required all cell phones and cell phone service providers have by the FCC since the mandate in 2005.

3. The Present invention creates a new process (method) of operation and location for Child Emergency Location Devices.
By using the operating and locating means and technology to create a CELD that operates on Cell phone service.
By using the cell phone service providers transmission mode technology (such as CDMA) to send the signal to the invention.
By using the cell phone identification codes, Electronic Serial Number (ESN), Mobile Identification number (MIN), System Identification Code (SID) to identify and locate the invention.
By using the service providers Mobile Telephone Switching Office (MTSO) to keep track of the invention's location in a database. This way, the MTSO knows which cell the invention is in and, therefore, can locate it in an abduction situation.
By using the MTSO's control channel to connect the invention and whomever is trying to find said invention by picking a pair of frequencies to use. Once the invention and tower switch on those frequencies, the connection is made and the location is known.
By using whatever type of GPS unit the cell phone has (such as Assisted Global Positioning System—AGPS) to create another means of locating the invention.
By using a GPS service provider to find the geographical location of the invention.
By parents or concerned parties using an APP program for a GPS service on a smart phone to find the location of the invention.
By the child or device wearer pressing the emergency 911 button on the device, the technology all cell phones and service providers are required to have by the FCC, will identify and transmit the contact number and location of the GELD immediately to 911.
By parents or concerned parties reporting an abduction by calling 911 and giving the contact number (provided by the service provider) of the CELD, in an emergency situation, Emergency 911 will know the location as soon as the connection is made.
